(19) United States
(12) Patent Application Publication
(10) Pub. No.: US 2022/0001322 A1
(43) Pub. Date: Jan. 6, 2022

(54) NEGATIVE-ION-HUMIDIFYING AIR PURIFIER BASED ON THE FLOW DIVERSION OF WATER PUMPS

(71) Applicant: Shenzhen Easehold Technology Co., Ltd., Shenzhen (CN)

(72) Inventor: Meihong Peng, Shenzhen (CN)

(21) Appl. No.: 17/447,943

(22) Filed: Sep. 17, 2021

(51) Int. Cl. B01D 47/06

(52) U.S. Cl. CPC B01D 47/06

(57) ABSTRACT

The present utility model discloses a negative-ion-humidifying air purifier. The negative-ion-humidifying air purifier includes an outer cup body and a top cover covering an upper end of the outer cup body, wherein the outer cup body is internally provided with an inner cup body, a PCB, and a first water pump; a gap is reserved between an outer wall of the inner cup body and an inner wall of the outer cup body; a water-spray tube body is disposed in the inner cup body; the outer cup body is provided with a frame that is above the inner cup body; the frame is provided with a counter impacting block that is directly above a water outlet of the water-spray tube body; top cover and outer cup body are each provided with an air-outlet mesh hole; and a fan is disposed in the top cover or the outer cup body.

### BACKGROUND OF THE INVENTION

### 1. Technical Field

The present utility model relates to the technical field of air cleaners, and in particular, relates to a negative-ion-humidifying air purifier based on the flow diversion of water pumps.

### 2. Description of Related Art

As is well-known, water at rest mostly exists in the form of large groups of molecules. After the water flows at high speed and undergoes collision, the large groups of water molecules are activated into small groups of molecules, which are further split to produce negative ions (OH−) that have many benefits for the human body.

At present, most of the existing air purifiers after being added with water atomize the water through an atomizing sheet, and then, the atomized water floats in the air to humidify the air. In this way, however, only a humidification effect is achieved, the overall air cleaning effect is less satisfactory, and the needs of users for a high-quality life cannot meet.

### BRIEF SUMMARY OF THE INVENTION

In view of the aforementioned defects in the prior art, an object of the present utility model is to provide a negative-ion-humidifying air purifier based on the flow diversion of water pumps.

To achieve the above object, the present utility model employs the following technical solution:

A negative-ion-humidifying air purifier based on the flow diversion of water pumps includes: an outer cup body and a top cover covering an upper end of the outer cup body, wherein the outer cup body is internally provided with an inner cup body, a PCB, and a first water pump that is electrically connected to the PCB; a gap is reserved between an outer wall of the inner cup body and an inner wall of the outer cup body; a water-spray tube body is disposed in the inner cup body; a water inlet tube of the first water pump is connected with a base of the inner cup body; a water outlet tube of the first water pump is connected with the water-spray tube body; the outer cup body is provided with a frame that is above the inner cup body; the frame is provided with a counter impacting block that is directly above a water outlet of the water-spray tube body; the top cover and the outer cup body are each provided with an air-outlet mesh hole; and a fan that is electrically connected to the PCB is disposed in the top cover or the outer cup body.

Preferably, a water cavity and an essence cavity are formed in the inner cup body through a division plate; the water inlet tube of the first water pump is connected with a base of the water cavity; the frame is provided with a liquid guiding cavity; the counter impacting block is provided with a liquid outlet which is connected with the liquid guiding cavity; the outer cup body is further internally provided with a second water pump that is electrically connected to the PCB; a water inlet tube of the second water pump is connected with a base of the essence cavity; and a water outlet tube of the second water pump is connected with the liquid guiding cavity.

Preferably, a surface of the counter impacting block is an arc-shaped face.

Preferably, the inner cup body is made of a transparent material, and a side face of the outer cup body is provided with a transparent window for observing the inner cup body.

Preferably, the outer cup body is provided with a control button and a USB interface, both of which are electrically connected to the PCB.

Due to the adoption of the solution described above, according to the present utility model, water in the inner cup body is diverted and pushed under a liquid diverting and pushing action of the water pump and then discharged from the water-spray tube body, so that the discharged water collides with the counter impacting block to produce corresponding splashes and create a waterfall effect, thereby endowing air inside the outer cup body with a negative-ion water mist. The air carrying the negative-ion water mist is then discharged to the outside through the fan, achieving a brand-new negative-ion air purifying effect.

### BRIEF DESCRIPTION OF THE SEVERAL VIEWS OF THE DRAWINGS

FIG. 1 is a schematic diagram of a structure principle according to Embodiment 1 of the present utility model.

FIG. 2 is a schematic diagram of an external structure of according to Embodiment 1 of the present utility model.

FIG. 3 is a schematic diagram of another structure without an essence cavity according to Embodiment 1 of the present utility model.

FIG. 4 is a schematic diagram of a structure principle according to Embodiment 2 of the present utility model.

FIG. 5 is a schematic diagram of a structure principle according to Embodiment 3 of the present utility model.

FIG. 6 is a schematic diagram of a structure principle according to Embodiment 4 of the present utility model.

### DETAILED DESCRIPTION OF THE INVENTION

The embodiments of the present utility model are illustrated below in detail in conjunction with the accompanying drawings. Nonetheless, the present utility model can be implemented in a variety of different modes defined and covered by the claims.

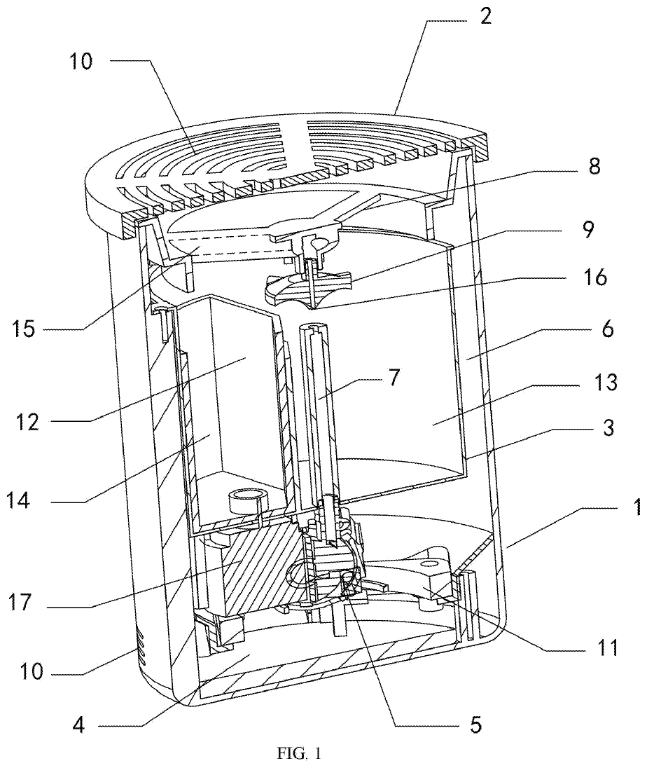

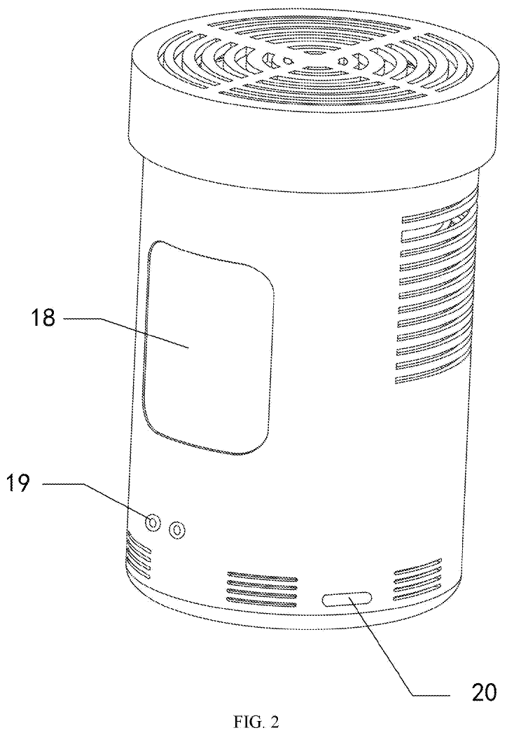

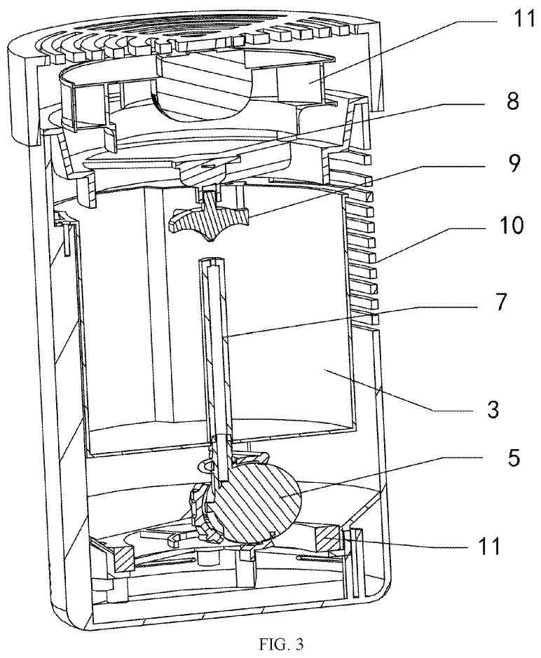

As shown in FIG. 1 to FIG. 3, Embodiment 1 provides a negative-ion-humidifying air purifier based on the flow diversion of water pumps. The negative-ion-humidifying air purifier includes an outer cup body 1 and a top cover 2 covering an upper end of the outer cup body 1; the outer cup body 1 is internally provided with an inner cup body 3, a PCB 4 and a first water pump 5 that is electrically connected to the PCB 4; a gap 6 is reserved between an outer wall of the inner cup body 3 and an inner wall of the outer cup body 1; a water-spray tube body 7 is disposed in the inner cup body 3; a water inlet tube of the first water pump 5 is connected with a base of the inner cup body 3; a water outlet tube of the first water pump 5 is connected with the water-spray tube body 7; the outer cup body 1 is provided with a frame 8 that is above the inner cup body 3; the frame 8 is provided with a counter impacting block 9 that is directly above a water outlet of the water-spray tube body 7; the top cover 2 and the outer cup body 1 are each provided with an air-outlet mesh hole 10; and a fan 11 that is electrically connected to the PCB 4 is disposed in the top cover 2 or the outer cup body 1.

Embodiment 1 is mainly implemented as follows: water in the inner cup body 3 is diverted and pushed under a liquid diverting and pushing action of the water pump and then discharged from the water-spray tube body 7, so that the discharged water collides with the counter impacting block 9 to produce corresponding splashes and create a waterfall effect, thereby endowing air inside the outer cup body 1 with a negative-ion water mist; and the air carrying the negative-ion water mist is then discharged to the outside through the fan 11, achieving a brand-new negative-ion air purifying effect.

The principle for creating the waterfall effect is as follows: the first water pump 5 starts working to pump water from the inner cup body 3 and discharge the water from the water-spray tube body 7; the discharged water collides with a counter impacting head under a pushing action of the water pump 5; after the continuous discharging and colliding of water, sufficient negative ions (OH−) are produced in the air; the fan 11 inside starts working to blow the air containing the negative ions to the outside to purify the outside air. Here, for the specific position of the fan 11, the fan 11 can be disposed at any position inside the top cover 2 and the outer cup body 1 in this embodiment, as long as an air flow discharged outwards carries the air containing the negative ions, which is not limited in this embodiment.

Further, essence (such as fragrance oil) can be added in this embodiment in order to improve a functional effect. In this regard, a water cavity 13 and an essence cavity 14 can be formed in the inner cup body 3 through a division plate 12 in this embodiment; the water inlet tube of the first water pump 5 is connected with a base of the water cavity 13; the frame 8 is provided with a liquid guiding cavity 15; the counter impacting block 9 is provided with a liquid outlet 16, which is connected with the liquid guiding cavity; the outer cup body 1 is further internally provided with a second water pump 17 that is electrically connected to the PCB; a water inlet tube of the second water pump 17 is connected with a base of the essence cavity 14; and a water outlet tube of the second water pump 17 is connected with the liquid guiding cavity 15. During the specific operation, water is added to the water cavity 13, and essence is added to the essence cavity 14; after starting working, the first water pump 5 works in the same way as described above to pump the water from the water cavity 13 to subsequently create a waterfall effect; while the waterfall effect is created, the second water pump 17 pumps the essence from the essence cavity 14 and then pushed the essence into the liquid guiding cavity 15 of the frame 8; the essence is subsequently discharged from the liquid outlet 16 of the counter impacting block 9, where the discharged essence is mixed with the water undergoing impacting and colliding here to endow the air carrying the negative ions with the essence as well; and the mixed air is discharged to the outside to enhance the effect of cleaning the outside air.

Further, in order to improve the counter impacting effect between the water and the counter impacting block 9, the surface of the counter impacting block 9 in this embodiment is an arc-shaped face, by which the effect of dispersing the counter impacted water can be increased, so that the waterfall effect can be enhanced, thereby increasing the efficiency in forming the negative ions in the air.

Further, as the cleaning operation continues, the liquid in the inner cup body 3 is consumed constantly. Therefore, in order to allow a user to more visually observe residual liquid in the inner cup body 3, the inner cup body 3 in this embodiment is made of a transparent material, and a side face of the outer cup body 1 is provided with a transparent window 18 for observing the inner cup body 3. By the arrangement of the transparent window 18, a user can directly observe the amount of liquid stored in the inner cup body 3 and watch the scene of the generated waterfall effect, thereby bringing a visual beauty to the user and putting fun into life.

Further, to implement the ordered operation on the whole, the outer cup body 1 in this embodiment is provided with a control button 19 and a USB interface 20, both of which are electrically connected to the PCB 4.

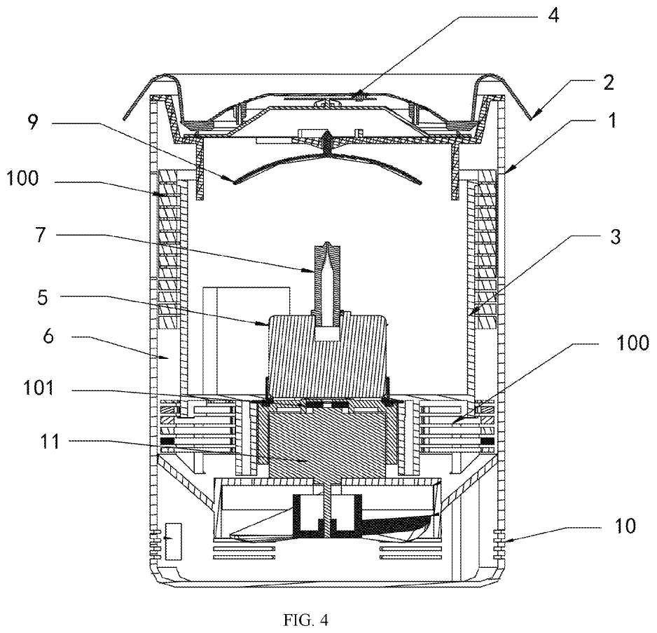

As shown in FIG. 4, Embodiment 2 provides a negative-ion-humidifying air purifier based on the flow diversion of water pumps. The negative-ion-humidifying air purifier includes an outer cup body 1 and a top cover 2 covering an upper end of the outer cup body 1; the outer cup body 1 is internally provided with an inner cup body 3 and a PCB 4; the inner cup body is internally provided with a first water pump 5 that is electrically connected to the PCB 4; a gap 6 is reserved between an outer wall of the inner cup body 3 and an inner wall of the outer cup body 1; the gap 6 is internally provided with an air filter 100; a water-spray tube body 7 is disposed in the inner cup body 3; a water inlet of the first water pump 5 is disposed at a base of the inner cup body 3; a water outlet tube of the first water pump 5 is connected with the water-spray tube body 7; the outer cup body 1 is provided with a frame 8 that is above the inner cup body 3; the frame 8 is provided with a counter impacting block 9 that is directly above a water outlet of the water-spray tube body 7; the top cover 2 and the outer cup body 1 are each provided with an air-outlet mesh hole 10; and a fan 11 that is electrically connected to the PCB 4 is disposed in the top cover 2 or the outer cup body 1.

Embodiment 2 is implemented mainly on the original basis of Embodiment 1, with a difference lying in an air filter that is additionally disposed in the gap 6. The air filter filters the air entering from the air-outlet mesh hole at the bottom, that is, the air filter filters the air introduced from the outside before the air contacts the water mist that is formed after impacting and colliding, thereby improving the quality of the finally discharged negative-ion air. Moreover, a shock pad 101 is disposed at a base of a motor of the fan 11 to achieve a cushioning effect for the fan 11 during operating.

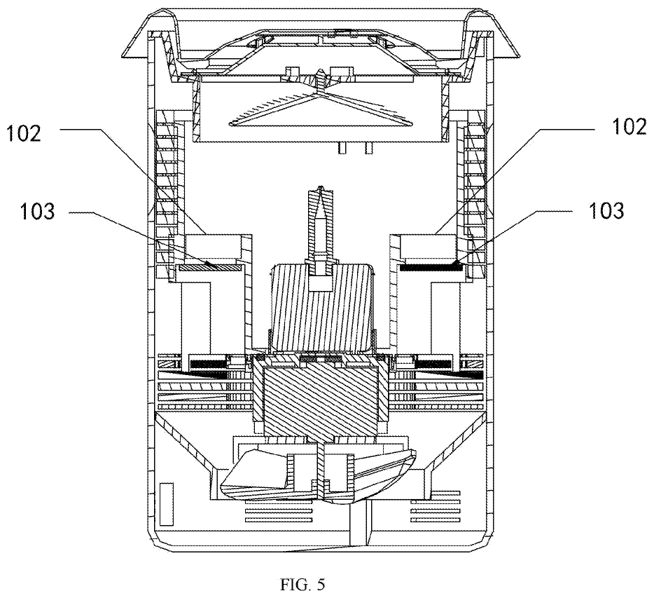

As shown in FIG. 5, Embodiment 3 provides a negative-ion air purifier based on the flow diversion of water pumps. The negative-ion air purifier based on the flow diversion of water pumps is similar to those in the previous embodiments in structure, with a difference in that at least one atomizing stage 102 is disposed in the inner cup body. The height of the atomizing stage 102 is higher than an impounded water level in the inner cup body 3. That is, when the negative-ion air purifier is in use, a liquid level in the inner cup body 3 should not be higher than the atomizing stage 102 after the liquid is added to the inner cup body 3. Moreover, the atomizing stage 102 is provided with an atomizing sheet 103 that is conductively connected to the PCB 4. During operating, after water or other liquid impacts and collides the counter impacting block, some of the liquid falls to the atomizing stage 102 and then atomized by the atomizing sheet 103 to produce more mist, thereby improving the air cleaning effect.

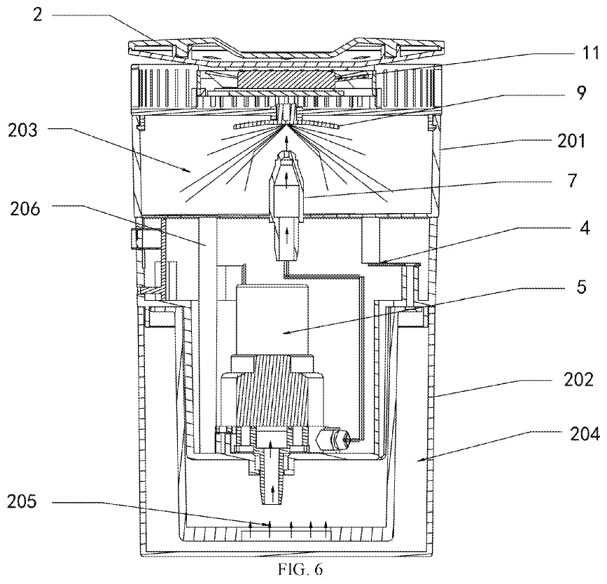

As shown in FIG. 6, Embodiment 4 provides a negative-ion air purifier based on the flow diversion of water pumps. The negative-ion air purifier based on the flow diversion of water pumps includes an upper cup body 201 and a lower cup body 202; the upper cup body 201 is sleeved on a cup opening of the lower cup body 202, and is provided with a spraying cavity 203; a first water pump 5 is mounted in the upper cup body 201 or in a cup cavity of the lower cup body 202; a counter impacting block 9 and a top cover 2 are both disposed on the upper cup body 201, and the counter impacting block 9 and a water-spray tube body 7 are disposed in the spraying cavity 203; the lower cup body 202 is provided with a refluxing cavity 204, and is provided with a connecting opening 205, which is responsible for connecting the refluxing cavity 204 with the cup cavity of the lower cup body 202; the upper cup body 201 is provided with a flow guiding channel 206, one end of which is connected to a base of the spraying cavity 203 and the other end of which is connected with the refluxing cavity 204 or the cup cavity of the lower cup body 202; a water inlet tube of the first water pump 5 is connected with the cup cavity of the lower cup body 202, and a water outlet tube of the first water pump 5 is connected with the water-spray tube body 7; and the fan is disposed on the top cover 2 for discharge air to the outside. Embodiment 4 is mainly distinctive from Embodiment 1 in the following: a separated structure design is adopted so that water can be filled and changed more conveniently, where the lower cup body 202 can be removed rapidly to conduct operations such as supplementing or changing a liquid inside the lower cup body 202; and moreover, electronic components are designed in a more centralized way (i.e., designed on the upper cup body 201 in a more centralized way), so that the lower cup body 202 is only for a purpose of storing water, and when the lower cup body 202 is operated, there is no need to worry about damaging the internal electronic components due to collision or other accidents.

Described above are merely preferred embodiments of the present utility model, but are not intended to thereby limit the patent scope of the present utility model. Any equivalent structures or equivalent flow transformations made based on the specification and drawings of the present utility model, or any direct or indirect applications to other relevant technical fields, shall be likewise construed as being included within the patent protection scope of the present utility model.

What is claimed is:

1. A negative-ion-humidifying air purifier based on the flow diversion of water pumps, comprising: an outer cup body and a top cover covering an upper end of the outer cup body, wherein the outer cup body is internally provided with an inner cup body, a PCB, and a first water pump that is electrically connected to the PCB; a gap is reserved between an outer wall of the inner cup body and an inner wall of the outer cup body; a water-spray tube body is disposed in the inner cup body; a water inlet tube of the first water pump is connected with a base of the inner cup body; a water outlet tube of the first water pump is connected with the water-spray tube body; the outer cup body is provided with a frame that is above the inner cup body; the frame is provided with a counter impacting block that is directly above a water outlet of the water-spray tube body; the top cover and the outer cup body are each provided with an air-outlet mesh hole; and a fan that is electrically connected to the PCB is disposed in the top cover or the outer cup body.

2. The negative-ion-humidifying air purifier based on the flow diversion of the water pumps according to claim 1, wherein a water cavity and an essence cavity are formed in the inner cup body through a division plate; the water inlet tube of the first water pump is connected with a base of the water cavity; the frame is provided with a liquid guiding cavity; the counter impacting block is provided with a liquid outlet which is connected with the liquid guiding cavity; the outer cup body is further internally provided with a second water pump that is electrically connected to the PCB; a water inlet tube of the second water pump is connected with a base of the essence cavity; and a water outlet tube of the second water pump is connected with the liquid guiding cavity.

3. The negative-ion-humidifying air purifier based on the flow diversion of the water pumps according to claim 2, wherein a surface of the counter impacting block is an arc-shaped face.

4. The negative-ion-humidifying air purifier based on the flow diversion of the water pumps according to claim 3, wherein the inner cup body is made of a transparent material, and a side face of the outer cup body is provided with a transparent window for observing the inner cup body.
